(19) United States
(12) Patent Application Publication
(10) Pub. No.: US 2002/0021222 A1
(43) Pub. Date: Feb. 21, 2002

(54) Sensor measuring field for monitoring micropipette function

(76) Inventors: Steffen Howitz, Dresden (DE); Mario Burger, Pirna (DE)

Correspondence Address: BAKER & BOTTS, 30 ROCKEFELLER PLAZA, NEW YORK, NY, 10112

(21) Appl. No.: 09/932,012

(22) Filed: Aug. 17, 2001

Related U.S. Application Data
(63) Continuation of application No. PCT/DE00/00455, filed on Feb. 18, 2000.

(30) Foreign Application Priority Data
Feb. 19, 1999 (DE) 199 06 966.2

(51) Int. Cl. G08B 21/00

(52) U.S. Cl. 340/603

(57) ABSTRACT

A sensor is provided for controlling functioning, e.g. for controlling drop delivery of a micropipette of a nanoplotter or the like and/or for determining the exact local drop deposition and/or its positional deviation from the envisaged deposition site and/or measuring the size of a drop. The invention aims at providing a sensor that makes it possible to detect delivery of a drop. According to the invention, this is done by using a point, line or planar shaped electrode (1) on at least one measuring field (3, 3′) that is connected to at least one electronic evaluation device (7) and on which at least one test drop (4) is deposited or dropped with the aid of the micropipette.

### BACKGROUND OF THE INVENTION

The invention relates to a sensor for monitoring function, e.g. for monitoring drop delivery, of a micropipette of a nanoplotter or the like, and/or for determining the exact spatial deposition of a drop and/or its position deviation from the intended deposition point and/or for measuring the size of a drop.

The primary field of application of the nanoplotter is considered the field of DNA analysis, molecular biology and protein synthesis.

Using a nanoplotter, a plurality of drops are distributed uniformly, which is to say in the form of a predefined array, on a deposition plate or on a paper roll or the like that is positioned thereupon. To this end, the nanoplotter is equipped with a micropipette that can be positioned as desired in the x and y directions at a delivery position over the deposition plate by means of a traversing mechanism. With the aid of the nanoplotter's x-y robotics system, the micropipette can be positioned over any point on the deposition plate under computer control at any time. The micropipette is used to take a small amount of any desired liquid from a storage vessel and then to deposit one or more microdroplets at the intended deposition point. To this end, the micropipette is equipped with a piezoelectrically driven micropump. The size of the deposited microdroplets is in the n1 or p1 range.

If the nanoplotter is used for such purposes as genetic engineering investigations, e.g. DNA analyses, or other biological investigations, it is necessary to ensure that each drop has been deposited on the intended deposition point in other words, that a 100% precise drop array has been created.

This requirement cannot be fully met with the prior art nanoplotters, since it is unavoidable that an intended drop event does not occur upon occasion. This may be due to accidental contamination of the micropipette, to gas bubbles in the micropipette, or perhaps to the circumstance that loading of the micropipette with a liquid was incomplete or did not occur.

In order to avoid this problem, high-resolution flow measurement could be provided, which however, aside from the considerable technical difficulty of the measurement, offers no certainty as to whether a drop has actually arrived at the intended destination as a result of the motion of the fluid.

The object of the invention is to create a sensor that makes it possible to detect the delivery of a drop, hence to realize functional monitoring of a micropipette.

### SUMMARY OF THE INVENTION

The object of the invention is achieved in a sensor of the aforementioned type through the use of an arrangement of electrodes in the form of a point, line or plane on at least one measurement area that is connected to an electronic analysis unit and upon which at least one test drop is deposited or placed by the micropipette.

In a first embodiment of the invention, the measurement area has a planar interdigitated double comb structure of mutually insulated metallic conductors on a substrate, each of which is connected to the electronic analysis unit.

In a second embodiment of the invention, ring electrodes that are arranged concentric to one another on a substrate are provided as the measurement area, each of which is electrically insulated from the others and is connected to the electronic analysis unit.

A third embodiment of the invention provides as the measurement area a uniform matrix of points of individual electrodes on a substrate, wherein the electrodes are connected either individually or in groups to the electronic analysis unit.

In a special embodiment of the invention, a stretched membrane that is connected to the electronic analysis unit is provided as the measurement area. This membrane can be set to oscillate in the vicinity of the resonance frequency with the aid of an oscillator circuit by means of magnetic or capacitive coupling, so that the oscillation damping or oscillation change that occurs when a test drop appears is transmitted to the electronic analysis unit.

The measurement area can also be designed as a temperature-controlled measurement surface, in which temperature sensors that are connected to an electronic analysis unit are associated with the sensor surface. Hence the increased energy requirement that occurs when a drop impacts the measurement surface can be evaluated as a sensor signal.

In a special variant of the invention, the measurement area has at least one optical sensor that is connected to the analysis circuit.

In order to determine the x-y offset of a drop placed on the measurement area, the measurement area has a matrix of linear electrodes in a plurality of rows and columns, wherein the electrodes of the matrix are electrically insulated from one another at their intersection points, and are each connected electrically to the analysis circuit. Preferably, the electrodes are spaced slightly apart from one another at the intersection points.

In order to achieve especially good spatial resolution in the center of the measurement area, the matrix of electrodes has a spatial gradient, i.e. the spacing of the intersection points becomes greater from the middle to the edges, where the intersection points in the central region of the measurement area have a constant, small spacing over a predefined region.

In another embodiment of the invention, the measurement area consists of concentrically arranged continuous or discontinuous electrode rings made of an electrically conductive material. Depending on the composition of the fluid to be plotted, the electrodes in the measurement area are made of a noble metal or of a plastic that is conductive at least on the surface.

The electrodes can also be applied to a planar or curved or arched surface of the substrate.

In a preferred embodiment, the planar surface of a nonconductor, for example a glass plate, a silicon plate, or a plastic, forms the base as a substrate for the electrode arrangement.

Manufacture of the sensor in accordance with the invention can be accomplished in a cost-effective manner by means of the known methods of microlithography and film technology.

Preferably, insulation of the electrodes from one another is accomplished by means of standing insulators, wherein the intersection points are opened with the aid of the customary etching processes, such as dry etching, or with the aid of a laser.

In another refinement of the invention, the electrodes are designed to be heatable.

In another special variant of the invention, two measurement areas are arranged adjacent to one another and a specific distance apart, each of which has extended, parallel electrodes, wherein the electrodes in one measurement area have a different orientation from the electrodes in the other measurement area. Preferably the electrodes in one measurement area are oriented vertically for measuring the x-position and/or deviation, and those in the other measurement area are oriented horizontally for measuring the y-position and/or deviation. In this way, the x-offset and y-offset of the deposited drop can be measured with particular precision.

In another embodiment of the invention, a CCD or CMOS image sensor, which is arranged above the measurement surface and which also can be part of an image recording device, is associated with the measurement area.

If the image recording device is designed such that it can be positioned together with the micropipette, direct monitoring of the drop deposition is possible.

The invention is described in detail below by means of exemplary embodiments.

### BRIEF DESCRIPTION OF THE DRAWINGS

FIG. 1 shows a sensor with a measurement area with a comb-like electrode arrangement;

FIG. 2 shows a sensor with a measurement area with a concentric electrode arrangement;

FIG. 3 shows a sensor with a measurement area with point electrodes;

FIG. 4 is a side view of a sensor with a membrane stretched over a substrate;

FIG. 5 shows a sensor with a measurement area with an electrode matrix of intersecting linear electrodes;

FIG. 6 shows a sensor with two measurement areas arranged a distance apart from one another; and

FIG. 7 shows a sensor with a segmented measurement area with concentric, discontinuous electrodes.

FIG. 8 shows a sensor having greater electrode spacing near the edges.

### DESCRIPTION OF THE INVENTION

Monitoring of the function of a micropipette of a nanoplotter in accordance with the invention can be achieved in a variety of ways. Thus, it is possible to use point, linear, or otherwise shaped electrodes 1 on a substrate 2 as function test sensors that are arranged so as to be electrically insulated from one another on the surface.

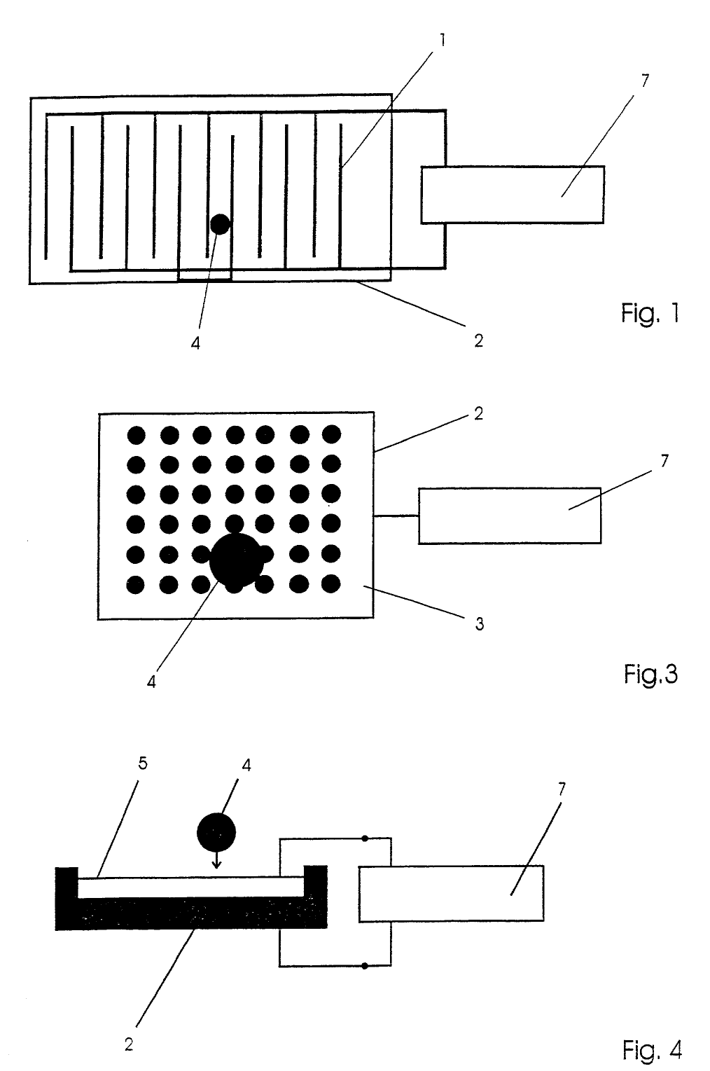

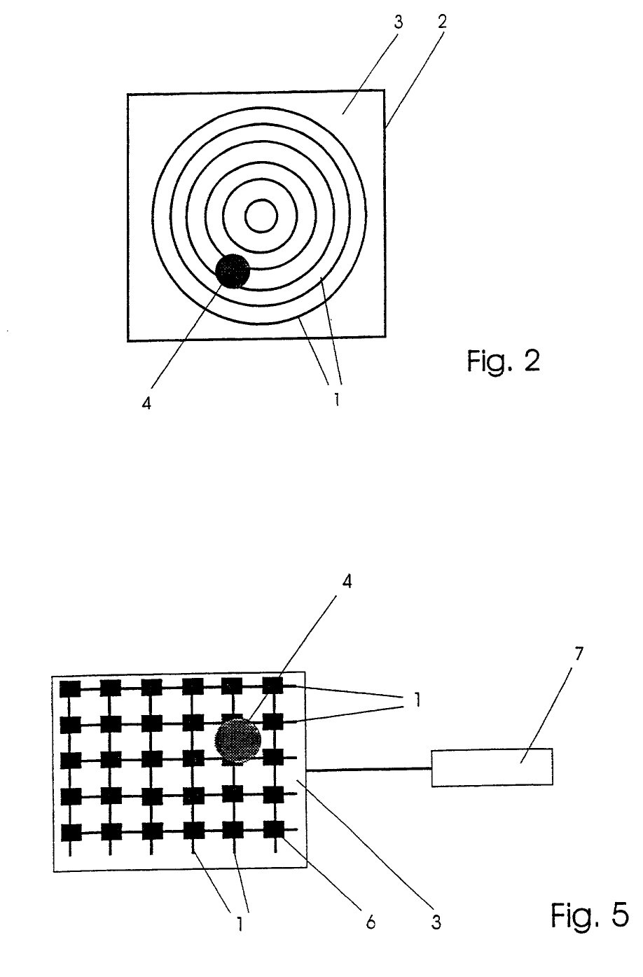

Such electrodes 1, which form a measurement area 3 on the substrate 2, can for example take the form of a double comb structure (FIG. 1), or else the form of concentric ring electrodes (FIG. 2). Another possibility is to construct the electrodes as a matrix of points (FIG. 3). The electrodes themselves can be made of any desired electrically conductive materials. The material that is used for the electrodes in each individual case is primarily a function of the composition of the liquid to be plotted.

When a test drop 4 impacts the electrode arrangement, or passes through it, electronic evaluation of the event can be undertaken on the basis of the change in the electrical parameters. The evaluation can be accomplished with the aid of capacitive, amperometric, conductometric or potentiometric measurement principles with which signals can be created that can be evaluated by an electronic analysis unit. It is also possible to use electrically charged test drops 4 so that the electrical impulse triggered by the drop 4 can be evaluated. In this case, even a single electrode, for example a single point electrode, is sufficient.

It is also possible to use a membrane 5 stretched over the substrate 2 as a function test sensor. With such a membrane 5 (FIG. 4), the impact of a drop 4 can reliably be detected in a variety of ways. When a drop 4 impacts the membrane 5 at any given impact speed, a certain deflection or oscillation excitation of the membrane will of necessity occur. In both cases, the influence of the impacting drop 4 on the membrane 5 can be evaluated by means of known optical or electrical measurement (capacitive, inductive) processes.

Another possibility for detecting the arrival of a drop 4 on the membrane 5 is to set the membrane 5 in oscillation at a predetermined frequency, for example at resonance frequency. This can be accomplished through magnetic or capacitive frequency coupling. When a drop 4 impacts the oscillating membrane 5, a damping, detuning, etc. will of necessity occur. This transitory change in the oscillation behavior can then easily be evaluated electronically with an electronic analysis unit 7.

An additional possibility for function monitoring consists of the use of a temperature-controlled measurement area 3. The applicable measurement principle here is based on the fact that a drop 4 impacting on the temperature-controlled measurement area 3 generates a temperature gradient. This temperature gradient can be measured by temperature-sensitive elements.

The possibility also exists of determining the energy requirement in the case of temperature regulation, since every arriving drop results in an increased energy requirement for temperature regulation in order to keep the temperature constant or to evaporate the drop. The changing energy requirement can be evaluated electronically so that reliable detection of an arriving drop can be accomplished.

Finally, functional monitoring can also be accomplished through the use of an optical sensor.

Reliable detection of a drop 4 can also be achieved with an optical sensor. To this end, a light-sensitive element, for example a photodiode or a phototransistor with or without interposed optical waveguides, is arranged in the intended measuring position below in the measurement area 3. When a drop 4 impacts the light-sensitive element, the intensity or quantity of light acting on the element is damped or intensified. In both cases, the change in the light intensity can be evaluated electronically. In order to achieve an increase in sensitivity, it is also possible to arrange a plurality of optical sensors, for example in the form of an array.

A special further development of the sensor consists in using the sensor as a position sensor in addition to the functional testing in that the measurement area 3 is embodied with a more extended area. In this case, the electrodes 1 are arranged on the surface at constant or variable spacing relative to one another, and thus make possible the spatial determination of arriving drops (FIGS. 2, 3, 7). In order to be able to implement this, the exact position of the pipette over the measurement area must of course be known. This information is provided by the microplotter's x-y robotics system.

To this end, an electrode matrix can be constructed of a plurality of rows and columns (FIG. 5), wherein the electrodes are electrically insulated from one another at their intersection points 6, for example are spaced a certain distance apart from one another.

When a drop 4 passes through the electrode matrix, in the event that at least one intersection point 6 (row/column) is crossed, an electronic evaluation can be undertaken by the electronic analysis unit 7 on the basis of the change in the electrical parameters. An intersection point 6 that has been wetted with liquid will behave differently when interrogated electronically than the other non-wetted intersection points 6. In this way, functional monitoring of the micropipette can be implemented. At the same time, a sensor of this nature can be used to determine the size of the x-y offset of the micropipette.

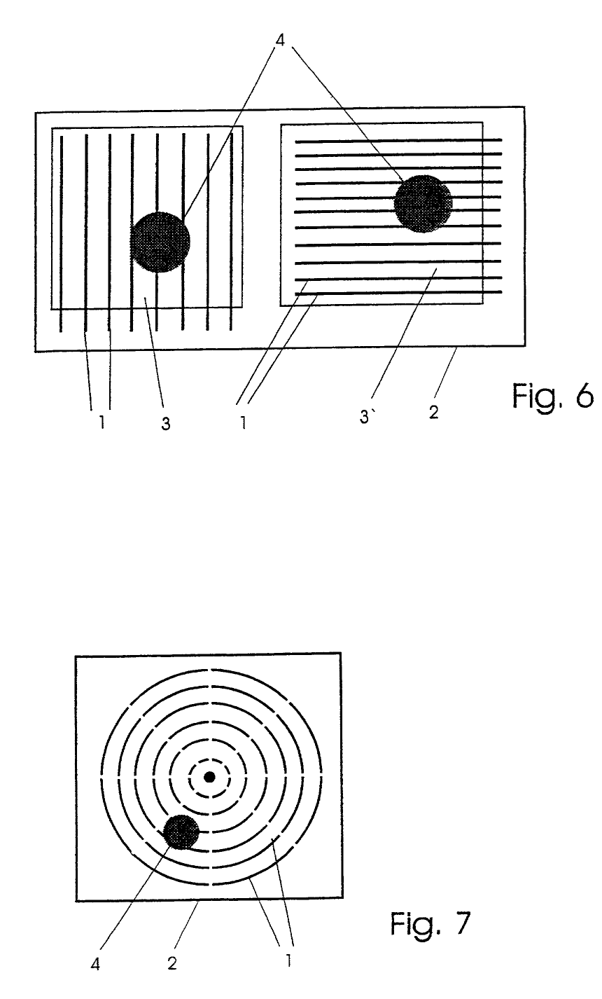

A variant can consist in providing two measurement areas 3, 3′ a specific distance apart on a substrate 2, each of which has parallel electrodes 1, and each of which has a different orientation from the other. In one measurement area, the electrodes can be oriented vertically for measuring the x-position, and those in the other measurement area can be oriented horizontally for measuring the y-position (FIG. 6). Of course, a precondition for this is that the precise position of the pipette that emits the drop 4 is known.

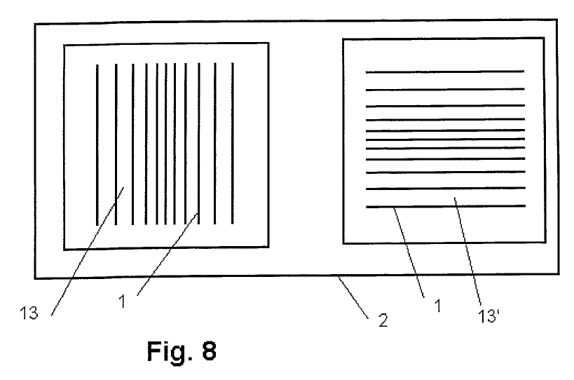

A further variant for implementing a measurement area is to provide concentrically arranged continuous or discontinuous electrode rings. Here, determination of the offset is accomplished by measuring the direction of the deviation and its size relative to the center of the sensor (FIG. 7).

It is also possible to provide point-shaped electrodes on the surface with mutually insulated connecting lines on the surface in the base material and/or on the back of the sensor, as can be seen schematically in FIG. 3, for example.

The applicable measurement principle (capacitive, amperometric, conductometric, potentiometric, etc.) and a suitable electronic analysis unit 7 permit adequately fast interrogation of all intersection points 6 of the matrix (FIG. 5), or of the segments of the electrode rings (FIG. 7) or of the matrix of point-shaped electrodes (FIG. 3).

With the sensors described, two measurement results are obtained, i.e. whether a drop has been deposited at all and if so, at what location, which is to say the deviation from the intended deposition point is determined so that the measurement results can be transmitted to the x-y robotics system of the nanoplotter.

To this end, the surface of the sensor must be larger than the intended deposition point.

The electrode matrix or the concentric rings are applied to a planar surface of the substrate 2, for example a glass or silicon base plate. The conductor traces can be produced by means of the known methods of microlithography and film technology. The lines and columns of the electrode matrix are insulated by means of standing inorganic insulators. The intersection points are opened with customary dry etching processes.

In order to improve the dynamics, the sensor can be regulated at a specific working temperature. In this case, crystallizing fluids (e.g. salt-containing crystallizing buffers) are plotted in arrays. These fluids make the sensor dirty in short order. For this reason, the sensor must be washable in addition to heatable. To avoid corrosion, at least the exposed conductor traces or the electrodes 1 are made of a noble metal.

For cleaning purposes, the sensor surface can be equipped with perforations. Cleaning can also be accomplished purely mechanically by the application of water and subsequent blotting dry.

In order to achieve adequate spatial resolution, the conductor trace width and the spacing of the intersection points is brought into correlation with the drop geometry.

It is possible to reduce the lines and columns. To this end, the matrix has a spatial gradient, i.e. the spacing of the electrodes' or intersection points 6 becomes greater from the center—where it is a constant, small size over a section—to the edges. One example is shown in FIG. 8 wherein measurement areas 13, 13′ have electrodes' with spatial gradient. Hence the matrix becomes less precise, in a defined manner, from the middle to the edges. This spatial gradient can likewise be implemented with concentrically arranged electrodes 1 as well as with the matrix of points.

A special sensor can be achieved with an optoelectronic sensor. CCD, CMOS and other image sensors are appropriate for this purpose. When sample drops are deposited on the sensor, the incident light in the photosensitive cells located under the drop is changed so that the sensor can provide position-based information.

In addition to or instead of the CCD image sensors, an image recording device, for example a video camera, can be arranged above the measurement area 3, 3′. This image recording device provides current images of each deposited drop and permits computer-supported image evaluation. If the image recording device is positioned together with the micropipette, each deposited optical drop can be analyzed.

The sensors described above are used in such a manner that sample deposition on the sensor is performed prior to each drop deposition by the nanoplotter. In the process, functional monitoring of the micropipette is accomplished at the same time as determination of the x- and y-offset of the micropipette, which information is transmitted to the nanoplotter's x-y robotics system. In this way, more precise arrays with a yield of 100% can be generated, although occasional failures of the micropipette cannot be ruled out. Moreover, it is possible to determine the size of the drops.

While there have been described what are believed to be the preferred embodiments of the invention, those skilled in the art will recognize that other and further changes can be made thereto without departing from the spirit of the invention, and it is intended to claim all such changes and modifications as fall within the true scope of the invention.

We claim:

1. Apparatus for sensing a drop of liquid delivered by a micropipette, comprising:
a sensor comprising electrodes arranged in a selected geometric pattern on a surface of a substrate over at least one measurement area, said electrodes being insulated from each other at said surface; and
an electronic analysis unit coupled to said electrodes for sensing changed electrical characteristics between said electrodes which result from a drop of liquid on said surface.

2. Apparatus as specified in claim 1, wherein said electrodes are arranged as a planar interdigital comb structure on said surface.

3. Apparatus as specified in claim 1, wherein said electrodes comprise a concentric pattern of electrodes.

4. Apparatus as specified in claim 1, wherein said electrodes comprise a matrix of linear electrodes arranged as intersecting rows and columns, said electrodes being insulated from each other at the intersections of said rows and columns.

5. Apparatus as specified in claim 4, wherein said electrodes are spaced from each other at said intersections.

6. Apparatus as specified in claim 5, wherein said spaces between said electrodes are formed by etching.

7. Apparatus as specified in claim 5, wherein said spaces between said electrodes are formed using a laser.

8. Apparatus as specified in claim 1, wherein said electrodes comprise at least one grid of parallel electrodes, and wherein said grid has a spatial gradient.

9. Apparatus as specified in claim 8, wherein said electrodes are arranged with the smallest spacing near a central portion of said measurement area.

10. Apparatus as specified in claim 1, wherein said electrodes are arranged as concentric rings.

11. Apparatus as specified in claim 10, wherein said rings are continuous.

12. Apparatus as specified in claim 10, wherein said rings comprise discontinuous angular segments.

13. Apparatus as specified in claim 1, wherein said electrodes are formed of a noble metal.

14. Apparatus as specified in claim 1, wherein said electrodes are formed of conductive plastic.

15. Apparatus as specified in claim 1, wherein said surface is planar.

16. Apparatus as specified in claim 1, wherein said surface is curved.

17. Apparatus as specified in claim 1, wherein said surface is non-conductive.

18. Apparatus as specified in claim 17, wherein said surface is formed on a substrate selected from the group glass, silicon and plastic.

19. Apparatus as specified in claim 1, wherein said electrodes are formed by microlithography.

20. Apparatus as specified in claim 1, wherein said electrodes are insulated from each other by standing insulators.

21. Apparatus as specified in claim 1, wherein said electrodes are arranged to be heated.

22. Apparatus as specified in claim 1, wherein two measurement areas are formed on said surface adjacent to each other and in a predetermined position with respect to each other, each measurement area having a set of parallel linear electrodes, the linear electrodes of one measurement area having a different angular orientation than the linear electrodes of the other measurement area.

23. Apparatus as specified in claim 23, wherein said linear electrodes of one area are perpendicular to the linear electrodes of the other area.
